(19) United States
(12) Patent Application Publication
(10) Pub. No.: US 2026/0360291 A1
(43) Pub. Date: Nov. 12, 2026

(54) DISPLAY DEVICE AND OPERATION METHOD OF DISPLAY DEVICE

(71) Applicant: LG ELECTRONICS INC., Seoul (KR)

(72) Inventors: Kyuri KIM, Seoul (KR); Yongjae JO, Seoul (KR); Yejin HONG, Seoul (KR)

(73) Assignee: LG ELECTRONICS INC., Seoul (KR)

(21) Appl. No.: 19/134,946

(22) PCT Filed: Dec. 14, 2022
(86) PCT No.: PCT/KR2022/020300

§ 371 Date: Jun. 2, 2025

(51) Int. Cl. G09G 3/20; G06T 5/40; G06T 5/94; G09G 3/3208

(52) U.S. Cl. CPC G09G 3/2007; G06T 5/94; G09G 3/3208; G06T 5/40; G06T 2207/20208; G09G 2320/0276; G09G 2320/066; G09G 2360/16

(57) ABSTRACT

A display device according to an embodiment of the present disclosure may include a controller which performs different tone mapping for each local area by using information on a local area of an image. The display device according to an embodiment of the present disclosure may include a controller which performs adaptive local tone mapping for each local area of an image on the basis of information on each corresponding local area.

### TECHNICAL FIELD

The present disclosure relates to a display device and a method for operating the display device.

The present disclosure relates to a display device and a method for operating the display device, and more particularly, to a method for tone mapping on an input image and a method for improving image quality.

### BACKGROUND ART

Digital images are generally composed of three channels of RGB, and generally SDR (Standard Dynamic Range) images can express brightness in the range of 0-255 (8 bits) for each channel. However, since the range of brightness that can be expressed in each channel is narrow in SDR images, dark areas are often not expressed properly or bright areas are not expressed properly. For example, in the case of images with a significant difference in brightness between dark and bright areas, such as photos taken under backlight, the contrast balance is biased to one side. Therefore, there can be a large difference between a scene seen with the naked eye and the SDR image that photographed it. In contrast to such SDR images, images that are expressed in 16 or 32 bits for each channel are referred to as HDR (High Dynamic Range) images, and HDR images have the advantage of being able to express images more realistically because they have a wider range of brightness expressiveness.

However, since general display devices cannot express 16-bit or 32-bit gradation, 16-bit or 32-bit HDR images need to be converted into digital images with a limited dynamic range. Tone mapping is used in the process of converting HDR images into SDR images or LDR (Low Dynamic Range) images, and can mean a technology that compresses the brightness area of an HDR image into the brightness area of an SDR image or LDR image while improving the contrast ratio.

A display device performs tone mapping on input image data to generate output image data, and outputs the generated output image data to a display. In order to output an image on a display that can improve the three-dimensionality and user immersion of the image through such tone mapping, various methods are being studied to improve the brightness and contrast ratio of the image.

### DISCLOSURE

### Technical Problem

An object of the present disclosure is to provide a display device that can further improve the three-dimensionality and user immersion of an image, and a method for the same.

An object of the present disclosure is to provide a display device that is capable of improving the brightness and contrast ratio of an image and, a method for the same.

An object of the present disclosure is to provide a display device that can improve the brightness and contrast ratio of an image by utilizing local area information of the image, and increase the three-dimensionality and user immersion of the image, and a method for the same.

An object of the present disclosure is to provide a display device that can further enhance the three-dimensionality and user immersion of an image by performing adaptive local tone mapping for each corresponding local area based on information on each local area of the image, and a method for the same.

### Technical Solution

A display device according to an embodiment of the present disclosure may include a controller that performs different tone mapping for each local area based on information of the local area of an image.

A display device according to an embodiment of the present disclosure may include a controller that performs adaptive local tone mapping for each corresponding local area based on information about each local area of an image.

A display device according to an embodiment of the present disclosure may include a controller performing tone mapping to adjust brightness of input image data; and an OLED display outputting an image according to output image data whose brightness has been adjusted by the tone mapping; in which the controller may generate a base mapping curve for the entire area based on the input image data, extracts brightness information for each local area of the entire area, and generate a local mapping curve in which the brightness information for each corresponding local area is reflected for each local area, thereby performing the tone mapping.

According to the display device according to an embodiment of the present disclosure, the base mapping curve may include a dynamic contrast curve for the entire area and a dynamic tone mapping curve for the entire area.

According to the display device according to an embodiment of the present disclosure, the controller may adaptively generate the local mapping curve for each local area based on the extracted brightness information for each local area and the base mapping curve.

According to the display device according to an embodiment of the present disclosure, the controller may set a local dimming intensity for the corresponding local area based on the brightness information for each local area, and adaptively process local pixel compensation for the corresponding local area based on the set local dimming intensity to generate the local mapping curve.

According to the display device according to an embodiment of the present disclosure, the controller, if the brightness of the corresponding local area is less than a first reference value, may set the local dimming intensity to be relatively weak, if the brightness of the corresponding local area is greater than a second reference value which is greater than the first reference value, set the local dimming not to be performed, and if the brightness of the corresponding local area is equal to or greater than the first reference value and equal to or less than the second reference value, set the local dimming to be relatively strong.

According to the display device according to an embodiment of the present disclosure, the controller, if the brightness of the corresponding local area is less than a first reference value, may process relatively weakly the local pixel compensation to generate the local mapping curve, if the brightness of the corresponding local area is greater than a second reference value which is greater than the first reference value, may not perform the local pixel compensation and maintains the base mapping curve, and if the brightness of the corresponding local area is equal to or greater than the first reference value and equal to or less than the second reference value, process relatively strongly the local pixel compensation to generate the local mapping curve.

According to the display device according to an embodiment of the present disclosure, the controller, if the brightness of the corresponding local area is less than the first reference value, may process relatively weakly the local pixel compensation to generate the local mapping curve, if the brightness of the corresponding local area is greater than the second reference value, may not perform the local pixel compensation and maintains the base mapping curve, and if the brightness of the corresponding local area is equal to or greater than the first reference value and equal to or less than the second reference value, process relatively strongly the local pixel compensation to generate the local mapping curve.

According to the display device according to an embodiment of the present disclosure, the controller, if the brightness of the corresponding local area is less than a first reference value, may generate the local mapping curve so that the contrast ratio is emphasized, if the brightness of the corresponding local area is greater than a second reference value which is greater than the first reference value, maintain the base mapping curve, and if the brightness of the corresponding local area is equal to or greater than the first reference value and equal to or less than the second reference value, generate the local mapping curve so that the brightness is enhanced.

A method for operating a display device according to an embodiment of the present disclosure may include generating a base mapping curve for an entire area based on input image data, extracting brightness information for each local area of the entire area, generates a local mapping curve in which the brightness information for each corresponding local area is reflected for each local area, thereby performing tone mapping on the input image data, and outputting an image according to output image data whose brightness is adjusted by the tone mapping to an OLED display.

According to the method for operating a display device according to an embodiment of the present disclosure, the base mapping curve may include a dynamic contrast curve for the entire area and a dynamic tone mapping curve for the entire area.

The method for operating a display device according to an embodiment of the present disclosure may further include adaptively generating the local mapping curve for each corresponding local area based on the extracted brightness information for each local area and the base mapping curve.

The method for operating a display device according to an embodiment of the present disclosure may further include generating the local mapping curve by setting a local dimming intensity for the corresponding local area based on the brightness information for each local area and adaptively processing local pixel compensation for the corresponding local area based on the set local dimming intensity.

According to the method for operating a display device according to an embodiment of the present disclosure, if the brightness of the corresponding local area may be less than a first reference value, the local dimming intensity is set to be relatively weak, if the brightness of the corresponding local area is greater than a second reference value which is greater than the first reference value, the local dimming may be set not to be performed, and if the brightness of the corresponding local area is equal to or greater than the first reference value and equal to or less than the second reference value, the local dimming may be set to be relatively strong.

According to the method for operating a display device according to an embodiment of the present disclosure, if the brightness of the corresponding local area is less than a first reference value, the local pixel compensation may be processed relatively weakly to generate the local mapping curve, if the brightness of the corresponding local area is greater than a second reference value which is greater than the first reference value, the local pixel compensation may be not performed and the base mapping curve is maintained, and if the brightness of the corresponding local area is equal to or greater than the first reference value and equal to or less than the second reference value, the local pixel compensation may be processed relatively strongly to generate the local mapping curve.

According to the method for operating a display device according to an embodiment of the present disclosure, if the brightness of the corresponding local area may be less than a first reference value, the local mapping curve is generated so that the contrast ratio is emphasized, if the brightness of the corresponding local area is greater than a second reference value which is greater than the first reference value, the base mapping curve may be maintained, and if the brightness of the corresponding local area is equal to or greater than the first reference value and equal to or less than the second reference value, the local mapping curve may be generated so that the brightness is enhanced.

### Advantageous Effect

According to the display device and the method for operating the same according to the embodiment of the present disclosure, the three-dimensionality the user's immersion of the image and can be further improved.

According to the display device and the method for operating the same according to the embodiment of the present disclosure, the brightness and contrast ratio of an image can be improved.

According to the display device and the method for operating the same according to the embodiment of the present disclosure, the brightness and contrast ratio of the image can be improved based on the local area information of the image, and the three-dimensionality and user immersion of the image can be increased.

According to the display device and the method for operating the same according to the embodiment of the present disclosure, adaptive local tone mapping is performed for each corresponding local area based on information about each local area of the image, thereby further improving the three-dimensionality and user immersion of the image.

### DESCRIPTION OF DRAWINGS

FIG. 1 is a block diagram illustrating a display device according to an embodiment of the present disclosure.

FIG. 2 is a block diagram illustrating a remote control device according to an embodiment of the present disclosure.

FIG. 3 illustrates an example of an actual configuration of a remote control device according to an embodiment of the present disclosure.

FIG. 4 illustrates an example of utilizing a remote control device according to an embodiment of the present disclosure.

FIG. 5 is a flowchart illustrating a method for operating a display device according to an embodiment of the present disclosure.

FIG. 6 is a view illustrating an example of local dimming of a typical LED display device.

FIG. 7 is a view illustrating an example of a dimming map of a typical LED display device.

FIG. 8 illustrates an example of pixel compensation according to local dimming of a typical LED display device.

FIG. 9 illustrates an example of local dimming and pixel compensation of a display device according to an embodiment of the present disclosure.

FIG. 10 illustrates an example of pixel compensation according to local dimming of a display device according to an embodiment of the present disclosure.

FIG. 11 illustrates input images and output images of a display device according to an embodiment of the present disclosure.

FIG. 12 illustrates an example of local pixel compensation applied to a low-gray area of FIG. 11 in a display device according to an embodiment of the present disclosure.

FIG. 13 illustrates an example of local pixel compensation applied to the intermediate-gradation area of FIG. 11 in a display device according to an embodiment of the present disclosure.

FIG. 14 illustrates an example of local pixel compensation applied to a high-gradation area of FIG. 11 in a display device according to an embodiment of the present disclosure.

### MODE FOR INVENTION

Hereinafter, embodiments relating to the present disclosure will be described in detail with reference to the accompanying drawings. The suffixes “interface,” “module,” and “unit” for components used in the description below are assigned or mixed in consideration of easiness in writing the specification and do not have distinctive meanings or roles by themselves.

A display device according to an embodiment of the present disclosure is an intelligent display device that adds a computer-assisted function to, for example, a broadcast reception function, and while remaining faithful to the broadcast reception function, adds an Internet function or the like and may have a more convenient interface such as a manual input device, a touch screen, or a space remote control. In addition, with the support of wired or wireless Internet functions, it is possible to access to the Internet and a computer, and perform functions such as email, web browsing, banking, or games. A standardized general-purpose OS may be used for these various functions.

Accordingly, the display device described in the present disclosure may perform various user-friendly functions, for example, since various applications may be freely added or deleted on a general-purpose OS kernel. More specifically, the display device may be, for example, a network TV, an HBBTV, a smart TV, an LED TV, an OLED TV, or the like and in some cases, may also be applied to a smartphone.

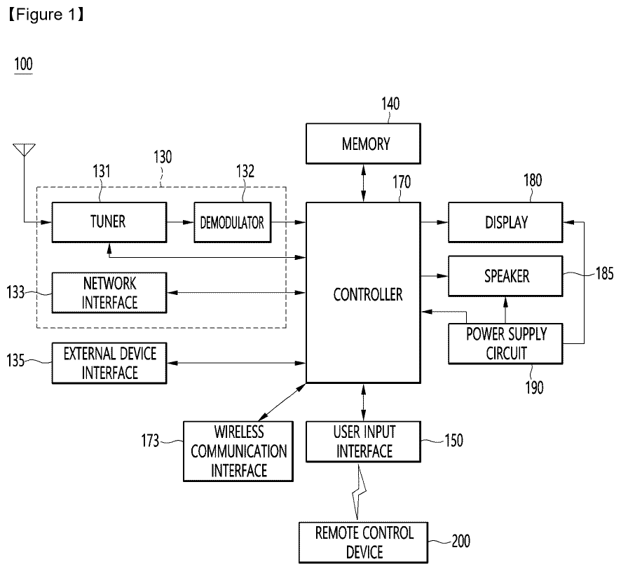

FIG. 1 is a block diagram illustrating a display device according to an embodiment of the present disclosure.

Referring to FIG. 1, the display device 100 may include a broadcast receiving part 130, an external device interface 135, a memory 140, a user input interface 150, a controller 170, a wireless communication interface 173, a display 180, a speaker 185, and a power supply circuit 190.

The broadcast receiving part 130 may include a tuner 131, a demodulator 132, and a network interface 133.

The tuner 131 can select a specific broadcast channel according to a channel selection command. The tuner 131 can receive a broadcast signal for the selected specific broadcast channel.

A demodulator 132 can separate a received broadcast signal into a video signal, an audio signal, and a data signal related to a broadcast program, and can restore the separated video signal, audio signal, and data signal into a form that can be output.

The external device interface 135 can receive an application or a list of applications within an adjacent external device and transmit them to the controller 170 or memory 140.

The external device interface 135 can provide a connection path between the display device 100 and the external device. The external device interface 135 can receive one or more of images and audio output from an external device connected wirelessly or wiredly to the display device 100 and transmit them to the controller 170. The external device interface 135 can include a plurality of external input terminals. The plurality of external input terminals can include an RGB terminal, one or more HDMI (High Definition Multimedia Interface) terminals, and a component terminal.

An image signal of an external device input through an external device interface 135 can be output through a display 180. A voice signal of an external device input through an external device interface 135 can be output through a speaker 185.

An external device that can be connected to the external device interface 135 may be any one of a set-top box, a Blu-ray player, a DVD player, a game console, a sound bar, a smartphone, a PC, a USB memory, and a home theater, but these are only examples.

The network interface 133 can provide an interface for connecting the display device 100 to a wired/wireless network including the Internet network. The network interface 133 can transmit or receive data to or from another user or another electronic device through the accessed network or another network linked to the accessed network.

In addition, some of the content data stored in the display device 100 can be transmitted to a selected user or electronic device among other users or other electronic devices pre-registered in the display device 100.

The network interface 133 can access a predetermined web page through an accessed network or another network linked to the accessed network. In other words, it can access a predetermined web page through a network and transmit or receive data with the corresponding server.

In addition, the network interface 133 can receive content or data provided by a content provider or a network operator. In other words, the network interface 133 can receive content such as movies, advertisements, games, VOD, broadcast signals, or the like, and information related thereto provided from a content provider or a network provider through a network.

Additionally, the network interface 133 can receive firmware update information and update files provided by the network operator, and transmit data to the Internet or content provider or network operator.

The network interface 133 can select and receive a desired application from among applications open to the public via a network.

The memory 140 stores programs for each signal processing and control within the controller 170 and can store processed images, voices, or data signals.

In addition, the memory 140 may perform a function for temporary storage of image, voice, or data signals input from an external device interface 135 or a network interface 133 and may also store information about a specific image through a channel memory function.

The memory 140 can store an application or a list of applications input from an external device interface 135 or a network interface 133.

The display device 100 can play content files (moving image files, still image files, music files, document files, application files, or the like) stored in the memory 140 and provide them to the user.

The user input interface 150 can transmit a signal input by the user to the controller 170, or transmit a signal from the controller 170 to the user. For example, the user input interface 150 can receive and process control signals such as power on/off, channel selection, and screen setting from the remote control device 200 according to various communication methods such as Bluetooth, Ultra Wideband (UWB), ZigBee, RF (Radio Frequency) communication, or infrared (IR) communication, or process control signals from the controller 170 to be transmitted to the remote control device 200.

In addition, the user input interface 150 can transmit control signals input from local keys (not illustrated) such as a power key, channel key, volume key, and setting key to the controller 170.

An image signal processed by the controller 170 may be input to the display 180 and displayed as an image corresponding to the image signal. In addition, an image signal processed by the controller 170 may be input to an external output device through an external device interface 135.

The voice signal processed in the controller 170 can be output as audio to the speaker 185. Additionally, the voice signal processed in the controller 170 can be input to an external output device through the external device interface 135.

In addition, the controller 170 can control the overall operation within the display device 100.

In addition, the controller 170 can control the display device 100 by a user command or an internal program input through the user input interface 150, and can access to a network to allow the user to download a desired application or application list into the display device 100.

The controller 170 enables the user-selected channel information or the like to be output through the display 180 or speaker 185 together with the processed image or audio signal.

In addition, the controller 170 allows an image signal or audio signal from an external device, for example, a camera or camcorder, input through the external device interface 135 to be output through the display 180 or speaker 185 in accordance with an external device image playback command received through the user input interface 150.

Meanwhile, the controller 170 can control the display 180 to display an image, for example, a broadcast image input through a tuner 131, an external input image input through an external device interface 135, an image input through a network interface part, or an image stored in a memory 140 can be controlled to be displayed on the display 180. In this case, the image displayed on the display 180 can be a still image or a moving image, and can be a 2D image or a 3D image.

In addition, the controller 170 can control the playback of content stored in the display device 100, received broadcast content, or external input content input from the outside, and the content can be in various forms such as broadcast images, external input images, audio files, still images, accessed web screens, and document files.

The wireless communication interface 173 can perform communication with an external device through wired or wireless communication. The wireless communication interface 173 can perform short range communication with an external device. To this end, the wireless communication interface 173 can support short range communication by using at least one of Bluetooth™, RFID (Radio Frequency Identification), Infrared Data Association (IrDA), UWB (Ultra Wideband), ZigBee, NFC (Near Field Communication), Wi-Fi (Wireless-Fidelity), Wi-Fi Direct, and Wireless USB (Wireless Universal Serial Bus) technologies. Such a wireless communication interface 173 can support wireless communication between the display device 100 and a wireless communication system, between the display device 100 and another display device 100, or between the display device 100 and a network where the display device 100 (or an external server) is located via a wireless area network. The wireless area network can be a wireless personal area network.

Here, the other display device 100 may be a wearable device (for example, a smartwatch, smart glass, a head mounted display (HMD)), a mobile terminal such as a smart phone, which can exchange data with (or be interworked to) the display device 100 according to the present disclosure. The wireless communication interface 173 may detect (or recognize) a wearable device capable of communication around the display device 100.

Furthermore, if the detected wearable device is a device authenticated to communicate with the display device 100 according to the present disclosure, the controller 170 can transmit at least a part of the data processed in the display device 100 to the wearable device via the wireless communication interface 173. Accordingly, a user of the wearable device can utilize the data processed in the display device 100 via the wearable device.

The display 180 can generate a driving signal by converting an image signal, data signal, OSD signal processed by the controller 170 or an image signal, data signal, or the like received from an external device interface 135 into R, G, and B signals, respectively.

Meanwhile, since the display device 100 illustrated in FIG. 1 is only an embodiment of the present disclosure, some of the illustrated components may be integrated, added, or omitted according to the specifications of the display device 100 actually implemented.

In other words, two or more components may be combined into one component, or one component may be subdivided into two or more components, as needed. In addition, the functions performed by each block are intended to explain the embodiments of the present disclosure, and the specific operations or devices thereof do not limit the scope of the present disclosure.

According to another embodiment of the present disclosure, unlike as illustrated in FIG. 1, the display device 100 may receive and play back an image through a network interface 133 or an external device interface 135 without having a tuner 131 and a demodulator 132.

For example, the display device 100 may be implemented separately as an image processing device, such as a set-top box for receiving contents according to broadcast signals or various network services, and a content playback device for playing contents input from the image processing device.

In this case, the method for operating a display device according to the embodiment of the present disclosure to be described below may be performed by any one of the display device 100 described with reference to FIG. 1, as well as an image processing device such as the separated set-top box, or a content playback device having a display 180 and an audio output part 185.

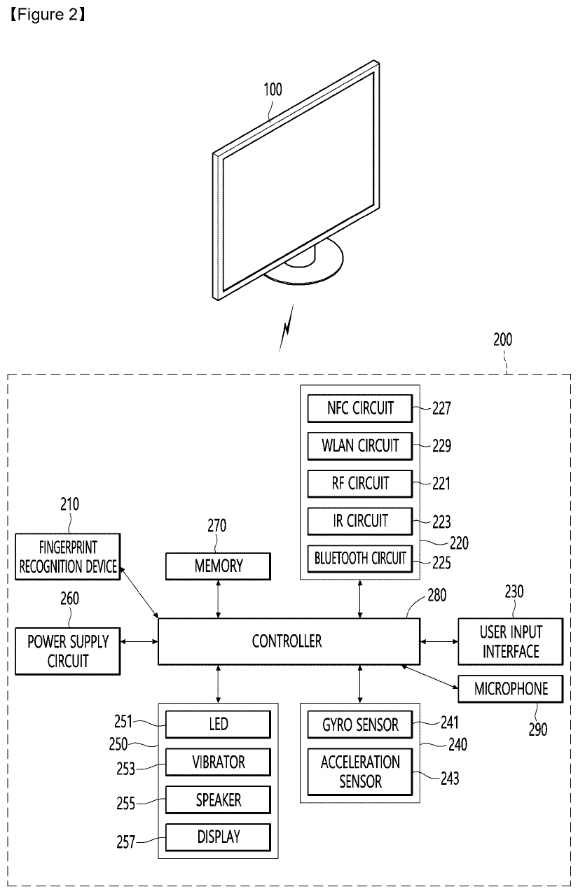

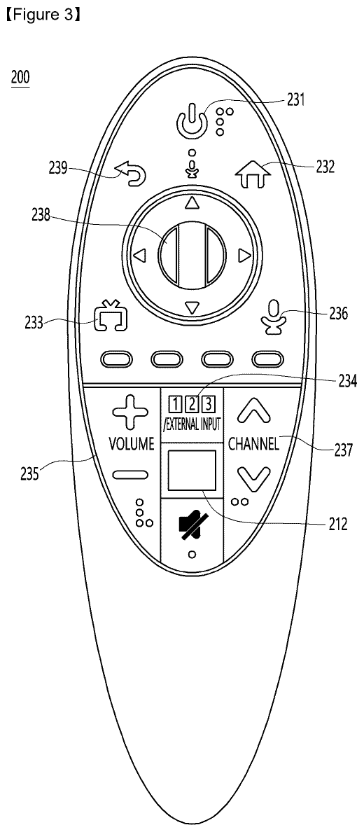

Next, a remote control device according to an embodiment of the present disclosure will be described with reference to FIGS. 2 and 3.

FIG. 2 is a block diagram illustrating a remote control device according to an embodiment of the present disclosure, and FIG. 3 illustrates an example of an actual configuration of a remote control device according to one embodiment of the present disclosure.

First, referring to FIG. 2, the remote control device 200 may include a fingerprint recognition device 210, a wireless communication circuit 220, a user input interface 230, a sensor 240, an output interface 250, a power supply circuit 260, a memory 270, a controller 280, and a microphone 290.

Referring to FIG. 2, the wireless communication circuit 220 transmits and receives signals with any one of the display devices according to the embodiments of the present disclosure described above.

The remote control device 200 may be equipped with an RF circuit 221 capable of transmitting and receiving signals with the display device 100 in accordance with RF communication standards, and an IR circuit 223 capable of transmitting and receiving signals with the display device 100 in accordance with IR communication standards. In addition, the remote control device 200 may be equipped with a Bluetooth circuit 225 capable of transmitting and receiving signals with the display device 100 in accordance with Bluetooth communication standards. In addition, the remote control device 200 may be equipped with an NFC circuit 227 capable of transmitting and receiving signals with the display device 100 in accordance with NFC (Near Field Communication) communication standards, and a WLAN circuit 229 capable of transmitting and receiving signals with the display device 100 in accordance with WLAN (Wireless LAN) communication standards.

In addition, the remote control device 200 transmits a signal containing information about the movement of the remote control device 200 to the display device 100 through a wireless communication circuit 220.

Meanwhile, the remote control device 200 can receive a signal transmitted by the display device 100 through the RF circuit 221, and, if necessary, can transmit commands for turning the power on/off, changing the channel, changing the volume, or the like to the display device 100 through the IR circuit 223.

The user input interface 230 may be composed of a keypad, a button, a touch pad, or a touch screen. The user may input a command related to the display device 100 to the remote control device 200 by operating the user input interface 230. If the user input interface 230 has a hard key button, the user may input a command related to the display device 100 to the remote control device 200 by pushing the hard key button. This will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume adjustment button 235, a voice recognition button 236, a channel change button 237, a confirmation button 238, and a back button 239.

The fingerprint recognition button 212 may be a button for recognizing a user's fingerprint. In an embodiment, the fingerprint recognition button 212 may be capable of a push operation, and may receive a push operation and a fingerprint recognition operation.

The power button 231 may be a button for turning the power of the display device 100 on/off.

The home button 232 may be a button for moving to the home screen of the display device 100.

The live button 233 may be a button for displaying a real-time broadcast program.

The external input button 234 may be a button for receiving an external input connected to the display device 100.

The volume adjustment button 235 may be a button for adjusting the size of the volume output by the display device 100.

The voice recognition button 236 may be a button for receiving a user's voice and recognizing the received voice.

The channel change button 237 may be a button for receiving a broadcast signal of a specific broadcast channel.

The confirmation button 238 may be a button for selecting a specific function, and the back button 239 may be a button for returning to the previous screen.

FIG. 2 is explained again.

When the user input interface 230 has a touch screen, the user can input a command related to the display device 100 using the remote control device 200 by touching a soft key of the touch screen. In addition, the user input interface 230 can have various types of input means that can be manipulated by the user, such as a scroll key or a jog key, and this embodiment does not limit the scope of the rights of the present disclosure.

The sensor 240 may be equipped with a gyro sensor 241 or an acceleration sensor 243, and the gyro sensor 241 may sense information about the movement of the remote control device 200.

For example, the gyro sensor 241 can sense information about the operation of the remote control device 200 based on the x, y, and z axes, and the acceleration sensor 243 can sense information about the movement speed of the remote control device 200. Meanwhile, the remote control device 200 can further be equipped with a distance measuring sensor, so as to sense the distance to the display 180 of the display device 100.

The output interface 250 can output an image or audio signal corresponding to a manipulation of the user input interface 230 or a signal transmitted from the display device 100.

The user can recognize whether the output interface 250 is manipulated by the user input interface 230 or is controlled by the display device 100.

For example, the output interface 250 may be equipped with an LED 251 that lights up if the user input interface 230 is manipulated or a signal is transmitted and received with the display device 100 via the wireless communication part 225, a vibrator 253 that generates vibrations, a speaker 255 that outputs sound, or a display 257 that outputs images.

In addition, the power supply circuit 260 supplies power to the remote control device 200, and reduces power waste by stopping the power supply if the remote control device 200 does not move for a predetermined period of time.

The power supply circuit 260 can resume power supply when a predetermined key provided in the remote control device 200 is manipulated.

The memory 270 can store various types of programs, application data, or the like required for the control or operation of the remote control device 200.

When the remote control device 200 wirelessly transmits and receives signals through the display device 100 and the RF circuit 221, the remote control device 200 and the display device 100 transmit and receive signals through a predetermined frequency band.

The controller 280 of the remote control device 200 can store and reference information about the frequency band or the like that can wirelessly transmit and receive signals with the display device 100 paired with the remote control device 200, in the memory 270.

The controller 280 controls all matters related to the control of the remote control device 200. The controller 280 can transmit a signal corresponding to a predetermined key manipulation of the user input interface 230 or a signal corresponding to the movement of the remote control device 200 sensed by the sensor 240 to the display device 100 through the wireless communication part 225.

Additionally, the microphone 290 of the remote control device 200 can acquire voice.

A plurality of microphones 290 may be provided.

Next, FIG. 4 is described.

FIG. 4 illustrates an example of utilizing a remote control device according to an embodiment of the present disclosure.

FIG. 4 (a) illustrates that a pointer 205 corresponding to a remote control device 200 is displayed on a display 180.

The user can move the remote control device 200 up and down, left and right, or rotate the remote control device. The pointer 205 displayed on the display 180 of the display device 100 corresponds to the movement of the remote control device 200. This remote control device 200 can be called a space remote control because, as illustrated in the drawing, the pointer 205 moves and is displayed according to the movement in 3D space.

FIG. 4 (b) exemplifies that if a user moves the remote control device 200 to the left, the pointer 205 displayed on the display 180 of the display device 100 also moves to the left correspondingly.

Information about the movement of the remote control device 200 detected through the sensor of the remote control device 200 is transmitted to the display device 100. The display device 100 can calculate the coordinates of the pointer 205 from the information about the movement of the remote control device 200. The display device 100 can display the pointer 205 to correspond to the calculated coordinates.

FIG. 4 (c) illustrates a case where a user moves the remote control device 200 away from the display 180 while pressing a specific button within the remote control device 200. As a result, a selection area within the display 180 corresponding to the pointer 205 can be zoomed in and displayed in an enlarged manner.

Conversely, if the user moves the remote control device 200 closer to the display 180, the selection area within the display 180 corresponding to the pointer 205 may be zoomed out and displayed in a reduced size.

Meanwhile, if the remote control device 200 moves away from the display 180, the selection area may be zoomed out, and if the remote control device 200 moves closer to the display 180, the selection area may be zoomed in.

In addition, when a specific button within the remote control device 200 is pressed, recognition of up, down, left, and right movements can be excluded. In other words, when the remote control device 200 moves away from or toward the display 180, up, down, left, and right movements are not recognized, and only forward and backward movements can be recognized. When a specific button within the remote control device 200 is not pressed, only the pointer 205 moves according to the up, down, left, and right movements of the remote control device 200.

Meanwhile, the movement speed or movement direction of the pointer 205 can correspond to the movement speed or movement direction of the remote control device 200.

Meanwhile, the pointer in this specification means an object displayed on the display 180 in response to the operation of the remote control device 200. Accordingly, objects of various shapes other than the arrow shape illustrated in the drawing are possible as the pointer 205. For example, it may be a concept including a point, a cursor, a prompt, a thick outline, or the like. In addition, the pointer 205 may be displayed corresponding to one point of the horizontal and vertical axes on the display 180, and may also be displayed corresponding to a plurality of points such as lines and surfaces.

A display device 100 according to an embodiment may include a controller 170 that performs tone mapping to adjust the brightness of input image data.

The display device 100 may include a display 180 that outputs an image according to output image data whose brightness is adjusted by tone mapping performed in the controller 170.

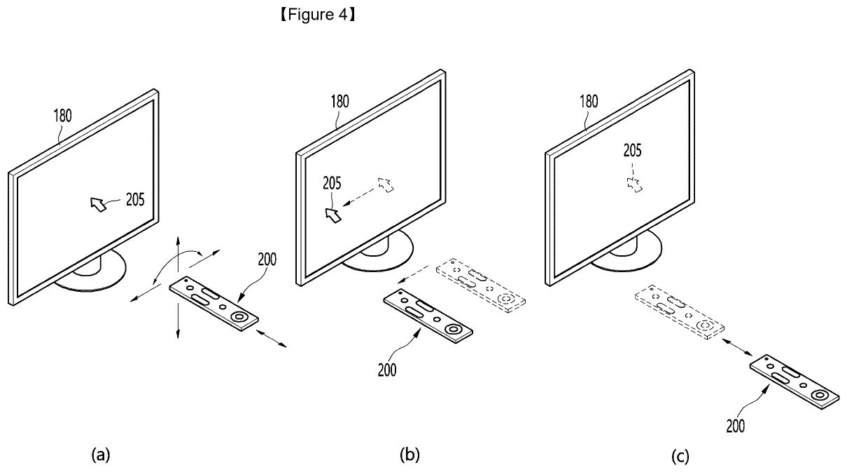

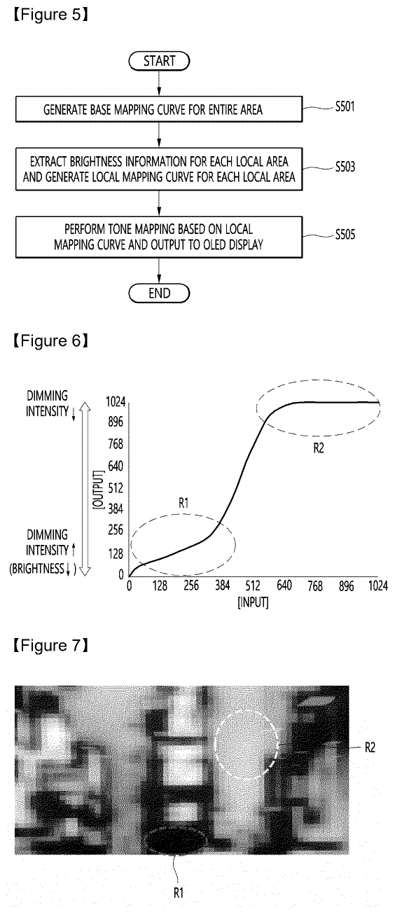

Hereinafter, a process of performing tone mapping in a display device according to an embodiment of the present disclosure will be described with reference to FIG. 5.

FIG. 5 is a flowchart illustrating a method for operating a display device according to an embodiment of the present disclosure.

The controller 170 of the display device 100 according to the embodiment can generate a base mapping curve for the entire area (S501).

According to the method for operating the display device 100 according to the embodiment, the controller 170 can generate a base mapping curve for the entire area based on input image data.

As an example, a base mapping curve can be generated through HDR (High Dynamic Range) processing of input image data.

The base mapping curve generated by the controller 170 may include a base dynamic tone mapping (DTM) curve for the entire area of the input image data. The base mapping curve may include a base dynamic contrast (DC) curve for the entire area of the input image data.

The base mapping curve may include at least one of a base dynamic tone mapping curve for the input image data or a base dynamic contrast curve for the input image data.

The controller 170 may receive metadata together with the image data when it receives the image data. The input image data may be an HDR image. The metadata may include information about the input image data. The metadata may include at least one of brightness information of the HDR image, maximum brightness information for each scene, or information for identifying the HDR image.

In addition, the controller 170 can calculate a brightness distribution histogram from the input image data. The brightness distribution histogram of the HDR image can mean distribution information of brightness values of each pixel of the HDR image. The controller 170 can calculate a brightness distribution histogram, which is a distribution diagram for signal levels (for example, 0 to 1023) of each pixel of the HDR image.

The base mapping curve can be generated based on image information including histogram information and APL (Average Picture Level) information of input image data.

The controller 170 can generate a base DTM (Dynamic Tone Mapping) curve based on brightness distribution histogram information for the input image data. The base DTM curve may mean a mapping curve in the RGB domain. In the RGB domain, mapping can be performed from the input image data to the output image data according to the generated base DTM curve.

The controller 170 can generate a base DC (Dynamic Contrast) curve. The base DC curve can mean a mapping curve in the brightness Y domain. In the brightness Y domain, mapping can be performed from input image data to output image data according to the generated base DC curve.

Meanwhile, methods for generating a base DTM curve or a base DC curve in a controller 170 to generate output image data suitable for the characteristics of a display 180 for input image data are known, so a detailed description thereof will be omitted here.

The controller 170 of the display device 100 according to the embodiment can extract brightness information for each local area of the entire area and generate a local mapping curve in which the brightness information for each corresponding local area is reflected for each local area (S503).

The controller 170 can adaptively generate a local mapping curve for each corresponding local area based on the extracted brightness information and base mapping curve for each local area.

The controller 170 can set a local dimming intensity for a corresponding local area based on brightness information for each local area, and adaptively process local pixel compensation for the corresponding local area based on the set local dimming intensity to generate a local mapping curve.

The controller 170 of the display device 100 according to the embodiment can perform tone mapping based on the generated local mapping curve and output an image according to output image data with adjusted brightness to the display 180 (S505).

A display device 100 according to an embodiment proposes a method for resolving a disadvantage in which areas in which a contrast ratio is felt to be insufficient occur in an output image if tone mapping is performed using a base DTM curve and a base DC curve based on image histogram information.

A display device 100 according to an embodiment sets a local dimming value in a dimming LUT (Look Up Table) based on local block information (for example, max R, G, B) in an image, and proposes a method of processing local pixel compensation for brightness compensation according to the local dimming amount.

A controller 170 according to an embodiment may include a dimming processor that sets a local dimming value and a pixel compensation processor that performs local pixel compensation.

With reference to FIGS. 6 to 8, local dimming and local pixel compensation of a display device including an LED display will be described.

FIG. 6 is a view illustrating an example of local dimming of a typical LED display device, FIG. 7 is a view illustrating an example of a dimming map of a typical LED display device, and FIG. 8 illustrates an example of pixel compensation according to local dimming of a typical LED display device.

The dimming LUT concept in a display device including an LED display according to an embodiment can be such that, as in the example of the dimming LUT in the LED display device illustrated in FIG. 6, a darker area can be made darker by applying a stronger dimming intensity, and a bright area can be maintained at a brightness level. As illustrated in FIGS. 6 and 7, the controller 170 can process a dark area R1 with a strong dimming intensity and a bright area R2 with a weak dimming intensity.

The controller 170 can compensate for the brightness of a corresponding local block by processing the local pixel compensation intensity to be stronger if the local dimming intensity for the local block is strong, as in the example of the pixel compensation LUT in the LED display device illustrated in FIG. 8.

In this way, the controller 170 can output image data with an improved contrast ratio to the display 180 by adjusting local dimming intensity and local pixel compensation intensity for the corresponding local area based on brightness information for each local area of the input image data.

One major difference between display devices that include LED displays and display devices that include OLED displays is the presence or absence of a backlight to provide light for displaying images.

The OLED displays do not require a backlight because each pixel is made of materials that emit light on their own. This can be the biggest advantage of OLED displays when expressing black. LED displays have the disadvantage of expressing black as a haze due to the backlight. To improve this, LED displays apply local dimming technology, turning off the backlight in the area where black should be expressed, thereby increasing the black expression. LED displays compensate by brightening the signal in the parts that cannot be expressed while turning off the backlight using the pixel compensation function.

OLED displays can set a wider range of blocks for local dimming than LED displays, and can set the size of blocks for local dimming smaller. For example, OLED displays can set the number of blocks for local dimming to 20,736(192*108 ). Therefore, OLED displays can design picture quality more locally and precisely than when handling local dimming in LED displays.

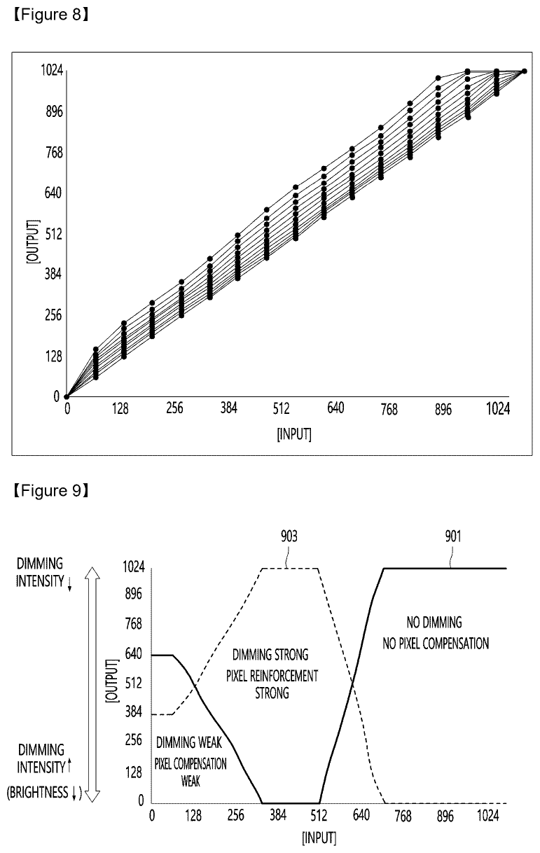

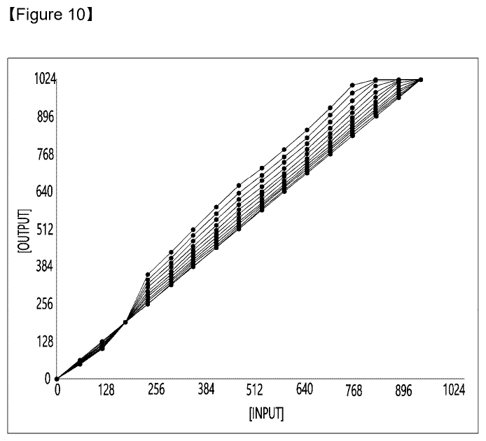

Hereinafter, a process of processing local area pixel compensation in a display device including an OLED display according to an embodiment of the present disclosure will be described with reference to FIGS. 9 and 10.

FIG. 9 illustrates an example of local dimming and pixel compensation of a display device according to an embodiment of the present disclosure, and FIG. 10 illustrates an example of pixel compensation according to local dimming of a display device according to an embodiment of the present disclosure.

According to a display device including an OLED display according to an embodiment, as indicated by the first line 901 in FIG. 9, the controller 170 can process by setting the local dimming intensity differently according to the brightness of each local area. The first line 901 illustrates an example of a dimming LUT and illustrates a change trend of the local dimming intensity according to the brightness of each local area.

The controller 170 can process dark local areas by setting the local dimming intensity to a low level, taking into account that black may appear to be floating or buried visually and is susceptible to noise.

The controller 170 can process local dimming intensity by setting it to the strongest in order to maximize the contrast ratio of the image for a local area with relatively medium brightness.

The controller 170 may not apply additional local dimming to maintain the bright local area without being affected by local dimming, considering that the distinction is poor and the brightness is reduced instead.

For example, the controller 170 may set the local dimming intensity to be relatively weak if the brightness of the corresponding local area is lower than the first reference value. For example, if the input brightness value is displayed in 1024 gradations, the first reference value may be 128 gradations. In addition, setting the local dimming intensity to be relatively weak may mean that if the output brightness value is displayed in 1024 gradations, the output brightness is set to be between 512 and 768 gradations.

The controller 170 may be set not to perform local dimming if the brightness of the corresponding local area is greater than a second reference value that is greater than the first reference value. For example, if the input brightness value is displayed in 1024 gradations, the first reference value may be 128 gradations and the second reference value may be 640 gradations. In addition, setting not to perform local dimming may mean that if the output brightness value is displayed in 1024 gradations, the output brightness is set to 1024 gradations.

The controller 170 may set the local dimming intensity to be relatively strong if the brightness of the corresponding local area is equal to or greater than the first reference value and equal to or less than the second reference value. For example, if the input brightness value is displayed in 1024 gradations, the first reference value may be 128 gradations and the second reference value may be 640 gradations. In addition, the local dimming intensity being set relatively strong may mean that, if the output brightness value is displayed in 1024 gradations, it is set to an output brightness of 0 gradations to 512 gradations. For example, if the input brightness value is 256 gradations to 512 gradations, the local dimming intensity may be set to the maximum and may be set to an output brightness of 0 gradations.

In a display device including an OLED display according to an embodiment, the controller 170 can set and process local pixel compensation for a local area with reference to a local dimming intensity set for the local area, as illustrated in FIGS. 9 and 10.

According to a display device including an OLED display according to an embodiment, as indicated by the second line 903 in FIG. 9, the controller 170 can process by setting the local pixel compensation intensity differently based on the brightness of each local area. The second line 903 illustrates a change trend of the local pixel compensation intensity according to the brightness of each local area, and FIG. 10 illustrates an example of a pixel compensation LUT.

The controller 170 can set and process pixel compensation to lower the brightness of areas with relatively low brightness and raise the brightness of remaining areas to improve the overall contrast ratio of the image, as can be seen in the pixel compensation LUT illustrated in FIG. 10.

For example, the controller 170 may generate and process a local mapping curve by relatively weakly processing the local pixel compensation if the brightness of the corresponding local area is lower than the first reference value. For example, when the input brightness value is expressed in 1024 gradations, the first reference value may be 128 gradations. The controller 170 may set and process the local pixel compensation to further lower the brightness of an area with low brightness in order to improve the contrast ratio of the image of the corresponding local area.

The controller 170 may maintain the base mapping curve without performing local pixel compensation if the brightness of the corresponding local area is greater than a second reference value that is greater than the first reference value. For example, if the input brightness value is expressed in 1024 gradations, the first reference value may be 128 gradations and the second reference value may be 640 gradations. In addition, setting not to perform local pixel compensation may mean that an area with relatively high brightness is set to maintain the input brightness without additional pixel compensation.

The controller 170 may generate a local mapping curve by processing the local pixel compensation intensity relatively strongly if the brightness of the corresponding local area is equal to or greater than the first reference value and equal to or less than the second reference value. For example, if the input brightness value is expressed in 1024 gradations, the first reference value may be 128 gradations and the second reference value may be 640 gradations. In addition, setting the local pixel compensation intensity relatively strongly may mean increasing the brightness of the corresponding local area, such as the pixel compensation LUT of FIG. 10, in order to improve the contrast ratio of the image.

According to the display device according to the embodiment, the controller 170 can generate a local mapping curve so that a contrast ratio is emphasized if the brightness of the local area is less than a first reference value, maintain a base mapping curve if the brightness of the corresponding local area is greater than a second reference value that is greater than the first reference value, and generate a local mapping curve so that the brightness is enhanced if the brightness of the local area is equal to or greater than the first reference value and equal to or less than the second reference value.

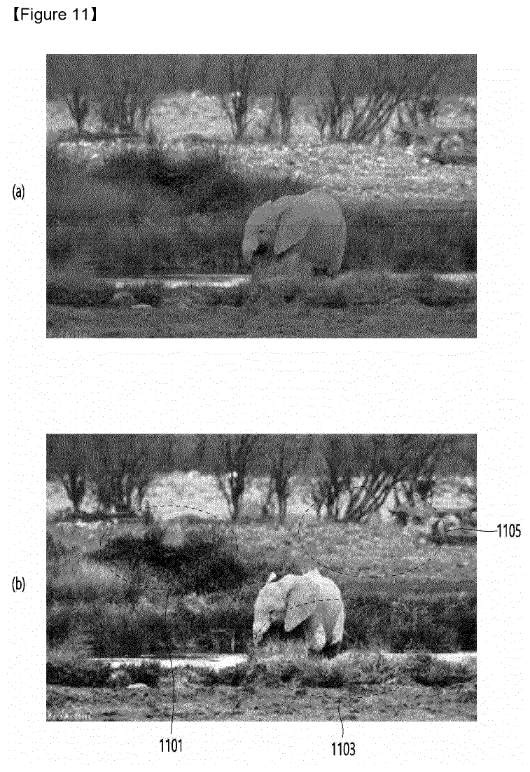

FIG. 11 illustrates input images and output images of a display device according to an embodiment of the present disclosure.

FIG. 11 (a) illustrates an example in which a base mapping curve is applied to the entire area based on input image data, and FIG. 11 (b) illustrates an output image in which local pixel compensation is added to the local area based on brightness information for each local area.

As illustrated in FIG. 11, the output image with local pixel compensation added to the local area can be seen to have improved brightness and contrast ratio overall.

In FIG. 11, the first area 1101 exemplifies a relatively low-gradation area, the second area 1103 exemplifies a relatively medium-gradation area, and the third area 1105 exemplifies a relatively high-gradation area.

The controller 170 according to the embodiment is applied different local pixel compensations to the first area 1101, the second area 1103, and the third area 1105, respectively. The controller 170 is adaptively applied different local dimming intensities and local pixel compensation intensities to the corresponding local areas based on the brightness information of each local area.

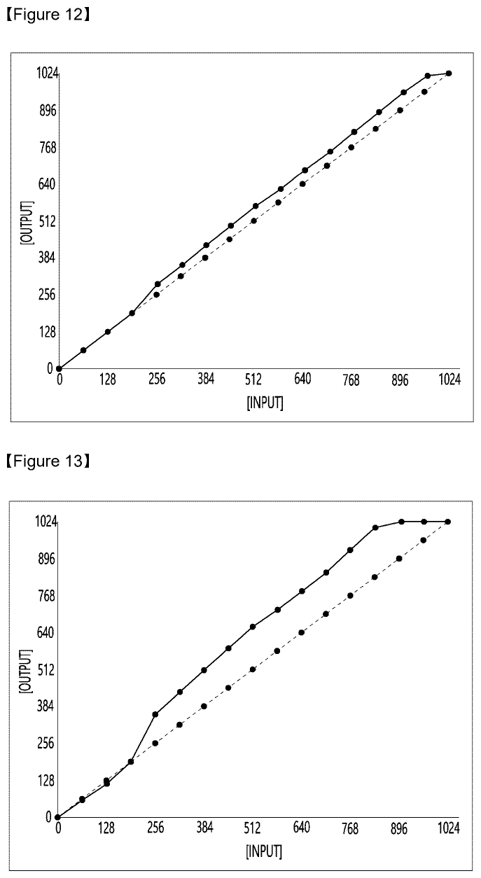

FIG. 12 illustrates an example of local pixel compensation applied to a low-gray area 1101 of FIG. 11 in a display device according to an embodiment of the present disclosure.

The controller 170 according to the embodiment sets weak local dimming and weak local pixel compensation for the low-gradation area 1101 so that the contrast ratio is emphasized, and processes local pixel compensation to lower the brightness in the relatively low-brightness area and raise the brightness in the remaining brightness area.

FIG. 13 illustrates an example of local pixel compensation applied to the intermediate-gradation area 1103 of FIG. 11 in a display device according to an embodiment of the present disclosure.

The controller 170 according to the embodiment sets strong local dimming and strong local pixel compensation for the intermediate-gradation area 1103 so that the contrast ratio can be maximized, and processes local pixel compensation to greatly lower the brightness in a relatively low brightness area and strongly increase the brightness in the remaining brightness area.

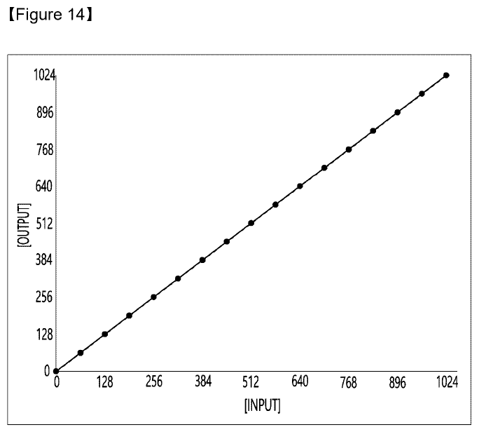

FIG. 14 illustrates an example of local pixel compensation applied to a high-gradation area 1105 of FIG. 11 in a display device according to an embodiment of the present disclosure.

The controller 170 according to the embodiment is set and processed to not perform local dimming and local pixel compensation so that the expressiveness of the image can be maintained according to the application of the base mapping curve for the high-gradation area 1105.

In this way, according to the OLED display device according to the embodiment, by adaptively performing local pixel compensation based on local area information of the image, the brightness and contrast ratio of the image can be improved, and the three-dimensionality and user immersion of the image can be increased.

According to an OLED display device according to an embodiment, the brightness and contrast ratio of an image can be improved by a stretching effect as the brightness of an intermediate-gradation area of an image increases and the brightness of a low-gradation area thereof decreases.

According to an embodiment of the present disclosure, the above-described method can be implemented as a processor-readable code on a medium in which a program is recorded. Examples of the processor-readable medium include a ROM, a RAM, a CD-ROM, a magnetic tape, a floppy disk, an optical data storage device, and the like.

The display device described above is not limited to the configuration and method of the embodiments described above, and the embodiments may be configured by selectively combining all or part of each embodiment so that various modifications can be made.

1. A display device comprising:
a controller performing tone mapping to adjust brightness of input image data; and
an OLED display outputting an image according to output image data whose brightness has been adjusted by the tone mapping;
wherein the controller generates a base mapping curve for the entire area based on the input image data, extracts brightness information for each local area of the entire area, and generates a local mapping curve in which the brightness information for each corresponding local area is reflected for each local area, thereby performing the tone mapping.

2. The display device of claim 1,
wherein the base mapping curve includes a dynamic contrast curve for the entire area and a dynamic tone mapping curve for the entire area.

3. The display device of claim 1,
wherein the controller adaptively generates the local mapping curve for each local area based on the extracted brightness information for each local area and the base mapping curve.

4. The display device of claim 1,
wherein the controller sets a local dimming intensity for the corresponding local area based on the brightness information for each local area, and adaptively processes local pixel compensation for the corresponding local area based on the set local dimming intensity to generate the local mapping curve.

5. The display device of claim 4,
wherein the controller,
if the brightness of the corresponding local area is less than a first reference value, sets the local dimming intensity to be relatively weak, if the brightness of the corresponding local area is greater than a second reference value which is greater than the first reference value, sets the local dimming not to be performed, and if the brightness of the corresponding local area is equal to or greater than the first reference value and equal to or less than the second reference value, sets the local dimming to be relatively strong.

6. The display device of claim 4,
wherein the controller,
if the brightness of the corresponding local area is less than a first reference value, processes relatively weakly the local pixel compensation to generate the local mapping curve,
if the brightness of the corresponding local area is greater than a second reference value which is greater than the first reference value, does not perform the local pixel compensation and maintains the base mapping curve, and
if the brightness of the corresponding local area is equal to or greater than the first reference value and equal to or less than the second reference value, processes relatively strongly the local pixel compensation to generate the local mapping curve.

7. The display device of claim 5,
wherein the controller,
if the brightness of the corresponding local area is less than the first reference value, processes relatively weakly the local pixel compensation to generate the local mapping curve,
if the brightness of the corresponding local area is greater than the second reference value, does not perform the local pixel compensation and maintains the base mapping curve, and
if the brightness of the corresponding local area is equal to or greater than the first reference value and equal to or less than the second reference value, processes relatively strongly the local pixel compensation to generate the local mapping curve.

8. The display device of claim 4,
wherein the controller,
if the brightness of the corresponding local area is less than a first reference value, generates the local mapping curve so that the contrast ratio is emphasized,
if the brightness of the corresponding local area is greater than a second reference value which is greater than the first reference value, maintains the base mapping curve, and
if the brightness of the corresponding local area is equal to or greater than the first reference value and equal to or less than the second reference value, generates the local mapping curve so that the brightness is enhanced.

9. A method for operating a display device comprising:
generating a base mapping curve for an entire area based on input image data,
extracting brightness information for each local area of the entire area, generates a local mapping curve in which the brightness information for each corresponding local area is reflected for each local area, thereby performing tone mapping on the input image data, and
outputting an image according to output image data whose brightness is adjusted by the tone mapping to an OLED display.

10. The method for operating a display device of claim 9,
wherein the base mapping curve includes a dynamic contrast curve for the entire area and a dynamic tone mapping curve for the entire area.

11. The method for operating a display device of claim 9, further comprising:
adaptively generating the local mapping curve for each corresponding local area based on the extracted brightness information for each local area and the base mapping curve.

12. The method for operating a display device of claim 9, further comprising:
generating the local mapping curve by setting a local dimming intensity for the corresponding local area based on the brightness information for each local area and adaptively processing local pixel compensation for the corresponding local area based on the set local dimming intensity.

13. The method for operating a display device of claim 12,
wherein, if the brightness of the corresponding local area is less than a first reference value, the local dimming intensity is set to be relatively weak,
wherein, if the brightness of the corresponding local area is greater than a second reference value which is greater than the first reference value, the local dimming is set not to be performed, and
wherein, if the brightness of the corresponding local area is equal to or greater than the first reference value and equal to or less than the second reference value, the local dimming is set to be relatively strong.

14. The method for operating a display device of claim 12,
wherein, if the brightness of the corresponding local area is less than a first reference value, the local pixel compensation is processed relatively weakly to generate the local mapping curve,
wherein, if the brightness of the corresponding local area is greater than a second reference value which is greater than the first reference value, the local pixel compensation is not performed and the base mapping curve is maintained, and
wherein, if the brightness of the corresponding local area is equal to or greater than the first reference value and equal to or less than the second reference value, the local pixel compensation is processed relatively strongly to generate the local mapping curve.

15. The method for operating a display device of claim 12,
wherein if the brightness of the corresponding local area is less than a first reference value, the local mapping curve is generated so that the contrast ratio is emphasized,
wherein if the brightness of the corresponding local area is greater than a second reference value which is greater than the first reference value, the base mapping curve is maintained, and
wherein if the brightness of the corresponding local area is equal to or greater than the first reference value and equal to or less than the second reference value, the local mapping curve is generated so that the brightness is enhanced.
